(19) United States
(12) Patent Application Publication
(10) Pub. No.: US 2026/0336262 A1
(43) Pub. Date: Oct. 29, 2026

(54) DECORATIVE FILM

(71) Applicant: 3M INNOVATIVE PROPERTIES COMPANY, St. Paul, MN (US)

(72) Inventor: Hidetoshi Abe, Tendo City (JP)

(21) Appl. No.: 19/157,186

(22) PCT Filed: Feb. 20, 2024
(86) PCT No.: PCT/IB2024/051623

§ 371 Date: Aug. 15, 2025

(30) Foreign Application Priority Data
Mar. 16, 2023 (JP) 2023-042240

(51) Int. Cl. B32B 7/06; B32B 7/12; C09J 11/06; C09J 133/20

(52) U.S. Cl. CPC B32B 7/06; B32B 7/12; C09J 11/06; C09J 133/20; B32B 2405/00

(57) ABSTRACT

A decorative film that has adequate slidability for positioning and repositioning of the decorative film, exhibits stable adhesion even under low temperature conditions, and has high decorative performance. A positionable and repositionable decorative film includes a film layer, an acrylic pressure-sensitive adhesive layer containing an acrylic adhesive polymer and a pigment, and a release liner. The acrylic adhesive polymer has a weight average molecular weight of 200000 to 350000 and a glass transition temperature of −10 °C or lower. The acrylic pressure-sensitive adhesive layer contains from 3 parts by mass to 60 parts by mass of the pigment per 100 parts by mass of the acrylic adhesive polymer, further contains a plurality of particle clusters separated from each other, and has protrusions each containing one or more of the particle clusters. The content of the acrylic adhesive polymer is from 70 mass % to 100 mass % based on the mass of all resin components.

### TECHNICAL FIELD

The present disclosure relates to a decorative film.

### BACKGROUND ART

Colored decorative films or decorative films exhibiting a metallic appearance are widely used in applications including markings on building construction signs, vehicles, ships, aircrafts, and the like; car wrapping; interior and exterior decorations of buildings; and illuminated signs. These decorative films are used at the time, for example, of production of vehicles or construction of buildings, or repair of vehicles or buildings.

Known methods for coloring the decorative film or imparting a metallic appearance to the decorative film include formation of an adhesive layer of the decorative film using an adhesive containing a pigment, such as titanium dioxide and/or metal flakes. Such an adhesive layer has two functions of coloring or imparting a metallic appearance and adhesion, and thus, with such an adhesive layer, the decorative film has a simple layer structure, and the coloring of the adhesive layer is excellent in terms of solvent resistance compared to coloring by solvent-based inkjet printing.

Patent Document 1 (JP 2009-203370 A) discloses “a marking film including: a colored base film layer; and an adhesive layer including an acrylic white adhesive, the adhesive layer being laminated on the colored base film layer, where the acrylic white adhesive contains a carboxyl group-containing (meth)acrylic polymer, 25 to 150 parts by mass of a white pigment with respect to 100 parts by mass of the carboxyl group-containing (meth)acrylic polymer, and an amino group-containing (meth)acrylic polymer containing no aromatic vinyl monomer”.

Patent Document 2 (JP 2003-183602 A) discloses “an adhesive sheet for decorative use, which is characterized by including an adhesive agent containing from 3 to 50 parts by weight of a white pigment relative to 100 parts by weight of a base polymer of the adhesive agent, and from 0.3 to 2 wt. % of aluminum metal pieces relative to the amount of the white pigment added, the adhesive agent being laminated on one surface of a colored film having a total light transmittance of 3 to 80%”.

Patent Document 3 (JP 2006-088593 A) describes “a metallic adhesive sheet for decorative use, which is obtained by laminating the following in this order: (A) an acrylic resin layer containing a UV absorbent and having a total light transmittance of 85% or higher relative to the visible light beam; (B) a metallic adhesive layer containing an acrylic adhesive, the acrylic adhesive having an aluminum metal powder and a pearl pigment blended therein; (C) a soft vinyl chloride resin layer that is colored; and (D) an acrylic adhesive layer”.

### CITATION LIST

### Patent Literature

Patent Document 1: JP 2009-203370 A
Patent Document 2: JP 2003-183602 A
Patent Document 3: JP 2006-088593 A

### SUMMARY OF INVENTION

### Technical Problem

Decorative films for outdoor use are desirably easy to work with, that is, have excellent workability, throughout the year including summer and winter. One of the characteristics concerning workability is slidability. With adequate slidability, positioning and repositioning of the decorative film is possible. Adhesives containing a pigment has high modulus of elasticity and thus tend to have reduced adhesion under low temperature conditions in winter. When such an adhesive is used to form an adhesive layer and, on the surface of the adhesive layer thus formed, a low-adhesive area is formed for imparting slidability, the adhesion stability is reduced in winter. On the other hand, when the content of the pigment is reduced to enhance adhesion under low temperature conditions, decorative performance, such as saturation and concealing property of the decorative film is reduced.

The present disclosure provides a decorative film that has slidability for positioning and repositioning of the decorative film, exhibits stable adhesion even under low temperature conditions, and has high decorative performance.

### Solution to Problem

The present inventor has found that combining an adhesive polymer with a specific molecular weight and a pigment can provide a pressure-sensitive adhesive composition having both properties of low modulus of elasticity and high cohesive force even under low temperature conditions, and that when slidability is imparted to a pressure-sensitive adhesive layer formed using the pressure-sensitive adhesive composition, stable adhesion can be obtained even under low temperature conditions.

According to an embodiment, there is provided a positionable and repositionable decorative film including:
a film layer,
an acrylic pressure-sensitive adhesive layer containing an acrylic adhesive polymer and a pigment, and
a release liner,
in which the acrylic adhesive polymer has a weight average molecular weight of 200000 to 350000,
the acrylic adhesive polymer has a glass transition temperature of −10 °C or lower,
the acrylic pressure-sensitive adhesive layer contains from 3 parts by mass to 60 parts by mass of the pigment based on 100 parts by mass of the acrylic adhesive polymer,
content of the acrylic adhesive polymer in the acrylic pressure-sensitive adhesive layer is from 70 mass % to 100 mass % based on mass of all resin components,
the acrylic pressure-sensitive adhesive layer further contains a plurality of particle clusters, the particle clusters each protruding from a surface of the acrylic pressure-sensitive adhesive layer or covered with the acrylic adhesive polymer; and the particle clusters being separated from each other, and the acrylic pressure-sensitive adhesive layer includes protrusions each containing one or more of the particle clusters, and
the release liner has depressions each protecting one or more of the particle clusters.

### Advantageous Effects of Invention

According to the present disclosure, there is provided a decorative film that has slidability for positioning and repositioning of the decorative film, exhibits stable adhesion even under low temperature conditions, and has high decorative performance.

Note that the above description is not construed as disclosure of all of the embodiments of the present invention and advantages related to the present invention.

### BRIEF DESCRIPTION OF DRAWINGS

FIG. 1 is a schematic cross-sectional view of a decorative film of an embodiment.

FIG. 2 is a schematic cross-sectional view of a decorative film of another embodiment.

### DESCRIPTION OF EMBODIMENTS

Hereinafter, the present invention will be described in more detail with reference to the drawings for the purpose of illustrating representative embodiments of the present invention, but the present invention is not limited to these embodiments.

In the present disclosure, the term “(meth)acrylic” refers to acrylic or methacrylic, and the term “(meth)acrylate” refers to acrylate or methacrylate.

In the present disclosure, the term “film” encompasses articles referred to as “sheets”.

In the present disclosure, “pressure-sensitive adhesive (ness)” refers to the characteristic of a material or composition that the material or composition adheres to various surfaces by application of little pressure for a short time in the temperature range of usage, such as from 0 °C to 50 °C, and does not exhibit a phase change (from liquid to solid). In the present disclosure, “adhesive (ness)” is used interchangeably with “pressure-sensitive adhesive (ness)”.

In the present disclosure, “disposed on” refers to not only the case of being directly disposed on, but also the case of being indirectly disposed on, that is, disposed via another material or layer on.

In the present disclosure, “titanium oxide” is used interchangeably with “titanium dioxide (TiO₂)”.

In the present disclosure, “weight average molecular weight” is a molecular weight by the gel permeation chromatography (GPC) method calibrated with polystyrene standards.

In the present disclosure, “all resin components” means all organic polymeric components or their precursors contained in an acrylic pressure-sensitive adhesive layer, including an acrylic adhesive polymer, a dispersant, and a crosslinking agent.

A positionable and repositionable decorative film of an embodiment includes a film layer, an acrylic pressure-sensitive adhesive layer containing an acrylic adhesive polymer and a pigment, and a release liner. A weight average molecular weight of the acrylic adhesive polymer is from 200000 to 350000, and a glass transition temperature of the acrylic adhesive polymer is-10 °C or lower. The acrylic pressure-sensitive adhesive layer contains from 3 parts by mass to 60 parts by mass of the pigment based on 100 parts by mass of the acrylic adhesive polymer, a content of the acrylic adhesive polymer in the acrylic pressure-sensitive adhesive layer is from 70 mass % to 100 mass % based on mass of all resin components, the acrylic pressure-sensitive adhesive layer further contains a plurality of particle clusters, the particle clusters each protruding from a surface of the acrylic pressure-sensitive adhesive layer or covered with the acrylic adhesive polymer, the particle clusters being separated from each other, and the acrylic pressure-sensitive layer has protrusions each containing one or more of the particle clusters. The release liner has depressions each protecting one or more of the particle clusters.

The film layer and the acrylic pressure-sensitive adhesive layer may be in a direct contact. Alternatively, another layer, such as a colored layer, a printed layer, or a bulk layer, may be interposed between the film layer and the acrylic pressure-sensitive adhesive layer. Another layer, such as a colored layer, a printed layer, a bulk layer, or a surface-protecting layer, may be laminated on the film layer. The decorative film may further include another functional layer, such as a primer layer that enhances adhesive properties between the film layer and the acrylic pressure-sensitive adhesive layer. A surface of the film layer, the surface being in contact with the acrylic pressure-sensitive adhesive layer, may be surface-treated, for example, by corona treatment or plasma treatment.

In an embodiment, the decorative film includes a film layer, an acrylic pressure-sensitive adhesive layer, and a release liner. The decorative film of this embodiment has a simple layer structure and thus can more advantageously accommodate regulations relating to flame retardance in each country.

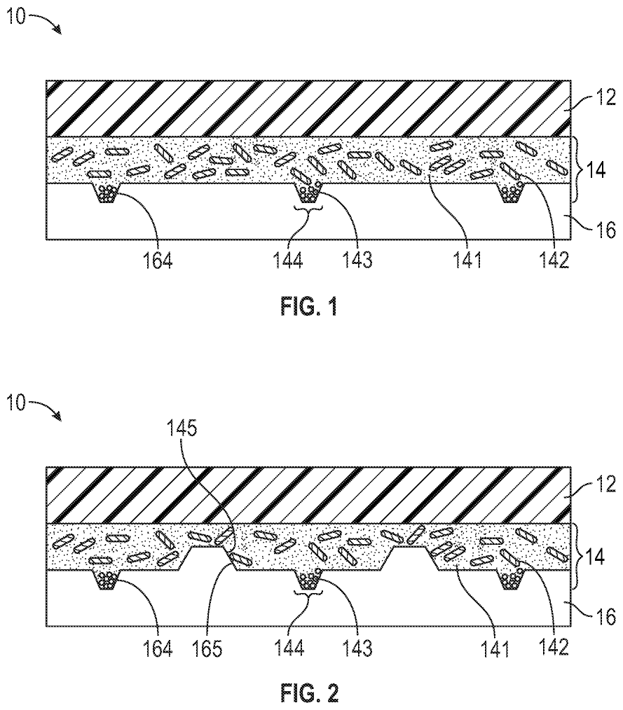

FIG. 1 illustrates a schematic cross-sectional view of a decorative film of an embodiment. A decorative film 10 has a film layer 12, an acrylic pressure-sensitive adhesive layer 14, and a release liner 16. The acrylic pressure-sensitive adhesive layer 14 contains an acrylic adhesive polymer 141 and a pigment 142 dispersed in the acrylic adhesive polymer 141.

Examples of the plastic film that can be used as the film layer include a polyethylene film, a polypropylene film, a polyester film, an acrylic resin film, a polycarbonate film, a poly(vinyl chloride) film, a poly(vinylidene chloride) film, a polyurethane film, a polystyrene film, a polyamide film, a vinylidene fluoride-based resin film, or a laminate of these. The film layer may be a thermoplastic elastomer film.

A thickness of the film layer may vary and can be, for example, approximately 5 μm or greater, approximately 10 μm or greater, or approximately 20 μm or greater, and approximately 500 μm or less, approximately 300 μm or less, or approximately 200 μm or less.

In an embodiment, a visible light transmission of the film layer is approximately 70% or greater, approximately 80% or greater, or approximately 90% or greater. In the present disclosure, “visible light transmittance” refers to an average visible light transmittance in the wavelength of 380 nm to 780 nm measured in accordance with JIS A 5759:2008.

The acrylic pressure-sensitive adhesive layer contains an acrylic adhesive polymer and a pigment.

The acrylic adhesive polymer can be obtained by polymerizing or copolymerizing a polymerizable composition containing a (meth)acrylic monomer and, as necessary, a monomer having another monoethylenic unsaturated group. In the present disclosure, a (meth)acrylic monomer and a monomer having another monoethylenic unsaturated group are collectively referred to as polymerizable components. The (meth)acrylic monomer and the monomer having another monoethylenic unsaturated group may be used in a combination of one type alone, or in combination of two or more types.

The (meth)acrylic monomer typically includes an alkyl (meth)acrylate. The number of carbon atoms of the alkyl group of the alkyl (meth)acrylate may be from 1 to 12. Examples of the alkyl (meth)acrylate include straight-chain or branched alkyl (meth)acrylate, such as methyl (meth)acrylate, ethyl (meth)acrylate, n-butyl (meth)acrylate, isobutyl (meth)acrylate, 2-methylbutyl (meth)acrylate, isoamyl (meth)acrylate, n-hexyl (meth)acrylate, n-octyl (meth)acrylate, isooctyl (meth)acrylate, 2-ethylhexyl (meth)acrylate, n-nonyl (meth)acrylate, isononyl (meth)acrylate, n-decyl (meth)acrylate, isodecyl (meth)acrylate, and n-dodecyl (meth)acrylate; and alicyclic (meth)acrylate, such as cyclohexyl (meth)acrylate, 4-t-butylcyclohexyl (meth)acrylate, and isobornyl (meth)acrylate. The alkyl (meth)acrylate preferably includes methyl acrylate, n-butyl acrylate, 2-methylbutyl acrylate, 2-ethylhexyl acrylate, isooctyl acrylate, or a combination of these.

The alkyl (meth)acrylate forms a main component of the acrylic adhesive polymer. In an embodiment, the acrylic adhesive polymer is obtained by copolymerizing a polymerizable composition containing the alkyl (meth)acrylate in an amount of approximately 50 mass % or greater, approximately 70 mass % or greater, or approximately 80 mass % or greater, and approximately 99.5 mass % or less, approximately 99 mass % or less, or approximately 98 mass % or less, with respect to the mass of the polymerizable components, and includes structural units derived from the alkyl (meth)acrylate in the mass ratio described above.

The (meth)acrylic monomer may include aromatic (meth)acrylate such as phenyl (meth)acrylate and p-tolyl (meth)acrylate; phenoxy alkyl (meth)acrylate such as phenoxy ethyl (meth)acrylate; alkoxy alkyl (meth)acrylate such as methoxypropyl (meth)acrylate and 2-methoxybutyl (meth)acrylate; or cyclic ether-containing (meth)acrylate such as glycidyl (meth)acrylate or tetrahydrofurfuryl (meth)acrylate.

The (meth)acrylic monomer or the monomer having another monoethylenic unsaturated group may include a polar monomer that is copolymerizable with the alkyl (meth)acrylate. Examples of the polar monomer include carboxy group-containing monomers such as (meth)acrylic acid, phthalic acid monohydroxyethyl (meth)acrylate, β-carboxyethyl (meth)acrylate, 2-(meth)acryloyloxyethyl succinic acid, 2-(meth)acryloyloxyethyl hexahydrophthalic acid, crotonic acid, itaconic acid, fumaric acid, citraconic acid, and maleic acid; amino group-containing monomers, including aminoalkyl (meth)acrylate such as aminoethyl (meth)acrylate, monoalkylaminoalkyl (meth)acrylate such as butylaminoethyl (meth)acrylate, dialkylaminoalkyl (meth)acrylate such as N,N-dimethylaminoethyl acrylate (DMAEA) and N,N-dimethylaminoethyl methacrylate (DMAEMA), dialkylaminoalkyl (meth)acrylamide such as N,N-dimethylaminopropyl acrylamide (DMAPAA) and N,N-dimethylaminopropyl methacrylamide, and dialkylaminoalkyl vinyl ether such as N,N-dimethylaminoethyl vinyl ether and N,N-diethylaminoethyl vinyl ether, amide group-containing monomers such as (meth)acrylamide, N-vinylpyrrolidone, and N-vinylcaprolactam; hydroxy group-containing monomers such as 2-hydroxyethyl (meth)acrylate, 2-hydroxypropyl (meth)acrylate, and 4-hydroxybutyl (meth)acrylate; and unsaturated nitrile such as (meth)acrylonitrile. These polar monomers can enhance cohesive force of the acrylic pressure-sensitive adhesive layer and improve adhesive strength.

Examples of the monomer having another monoethylenic unsaturated group include aromatic vinyl monomers such as styrene, α-methylstyrene, and vinyl toluene; and vinyl esters such as vinyl acetate.

The acrylic adhesive polymer is preferably a carboxy group-containing (meth)acrylic polymer. The carboxy group-containing (meth)acrylic polymer can be obtained by copolymerizing a polymerizable composition containing a carboxy group-containing monomer as a polymerizable component. The carboxy group-containing (meth)acrylic polymer can enhance adhesive strength by enhancing cohesive force by the presence of the carboxy group. The carboxy group-containing (meth)acrylic polymer may be able to enhance adhesive properties between the film layer and the acrylic pressure-sensitive adhesive layer. As the carboxy group-containing monomer, (meth)acrylic acid is preferred.

In an embodiment, the carboxy group-containing (meth)acrylic polymer is obtained by copolymerizing a polymerizable composition containing the carboxy group-containing monomer in an amount of approximately 0.5 mass % or greater, approximately 1 mass % or greater, or approximately 2 mass % or greater, and approximately 15 mass % or less, approximately 10 mass % or less, or approximately 8 mass % or less, relative to the mass of the polymerizable components, and includes structural units derived from the carboxy group-containing monomer in the mass ratio described above.

The polymerization or copolymerization of the acrylic adhesive polymer can be performed by radical polymerization. As the radical polymerization, a known polymerization method can be utilized, such as solution polymerization, suspension polymerization, emulsion polymerization, and bulk polymerization. It is advantageous to use solution polymerization that can easily synthesize a polymer with a high molecular weight. As the polymerization initiator, for example, an organic peroxide such as benzoyl peroxide, lauroyl peroxide, or bis(4-tert-butylcyclohexyl) peroxydicarbonate; or an azo-based polymerization initiator such as 2,2′-azobisisobutyronitrile, 2,2′-azobis(2-methylbutyronitrile), dimethyl-2,2-azobis (2-methylpropionate), 4,4′-azobis (4-cyanovalerianic acid), dimethyl 2,2′-azobis (2-methylpropionate), or azobis (2,4-dimethylvaleronitrile) (AVN) can be used. The polymerization initiator is used typically in an amount of approximately 0.01 parts by mass or greater, or approximately 0.05 parts by mass or greater, and approximately 5 parts by mass or less, or approximately 3 parts by mass or less, relative to 100 parts by mass of the polymerizable components.

The glass transition temperature (Tg) of the acrylic adhesive polymer is approximately-10 °C or lower. When the acrylic adhesive polymer has a glass transition temperature of approximately-10 °C or lower, pressure-sensitive adhesion and slidability can be imparted to the acrylic pressure-sensitive adhesive layer in a wide temperature range (e.g., from 0 °C to 40 °C). In an embodiment, the glass transition temperature of the acrylic adhesive polymer is approximately-20 °C or lower or approximately-35 °C or lower. In an embodiment, the glass transition temperature of the acrylic adhesive polymer is approximately-70 °C or higher, approximately-65 °C or higher, or approximately −60 °C or higher. When the acrylic adhesive polymer has a glass transition temperature of approximately-70 °C or higher, adhesive strength and holding force can be imparted to the acrylic pressure-sensitive adhesive layer.

The glass transition temperature (Tg) of the acrylic adhesive polymer can be determined as a calculated glass transition temperature, using the following Fox equation (Fox, T. G., Bull. Am. Phys. Soc., 1 (1956), p. 123) assuming that each polymer is copolymerized from n types of monomers:

$$\frac{1}{Tg + 273.15} = {\sum }_{i = 1}^{n} ( \frac{{X}_{i}}{{Tg}_{i} + 273.15} ) \qquad [ Math . 1 ]$$

In the equation, Tgᵢ represents the glass transition temperature (°C) of a homopolymer of a component i, Xᵢ represents the mass fraction of the monomer of the component i added during polymerization, and i is a natural number of 1 to n, and

$${\sum }_{i = 1}^{n} {X}_{i} = 1 \qquad [ Math . 2 ]$$

A weight average molecular weight (Mw) of the acrylic adhesive polymer is from approximately 200000 to approximately 350000. With the acrylic adhesive polymer having the weight average molecular weight in the above range, both properties of low modulus of elasticity and high cohesive force can be imparted to the acrylic pressure-sensitive adhesive layer even under low temperature conditions, and stable adhesion can be provided even under low temperature conditions when slidability is imparted to the pressure-sensitive adhesive layer formed using the pressure-sensitive adhesive composition. In an embodiment, the weight average molecular weight of the acrylic adhesive polymer is approximately 220000 or greater or approximately 250000 or greater, and approximately 320000 or less or approximately 300000 or less.

The pigment contained in the acrylic pressure-sensitive adhesive layer can impart decorativeness or concealing property, or both decorativeness and concealing property to the decorative film. One type of pigment may be used, or two or more types of pigments may be used in combination.

A content of the pigment in the acrylic pressure-sensitive adhesive layer is from approximately 3 parts by mass to approximately 60 parts by mass based on 100 parts by mass of the acrylic adhesive polymer. When the acrylic pressure-sensitive adhesive layer contains approximately 3 parts by mass or more of the pigment based on 100 parts by mass of the acrylic adhesive polymer, at least one of decorativeness or concealing property can be imparted to the decorative film. When the acrylic pressure-sensitive adhesive layer contains approximately 60 parts by mass or less of the pigment based on 100 parts by mass of the acrylic adhesive polymer, adhesion under low temperature conditions can be enhanced. In an embodiment, a content of the pigment in the acrylic pressure-sensitive adhesive layer is approximately 5 parts by mass or greater, or approximately 10 parts by mass or greater, and approximately 55 parts by mass or less, or approximately 50 parts by mass or less per 100 parts by mass of the acrylic adhesive polymer. When two or more types of pigments are used, the content of the pigment is the total content of those pigments.

Examples of the pigment include inorganic pigments, such as titanium oxide, zinc carbonate, zinc oxide, zinc sulfide, calcium carbonate, barium sulfate, talc, kaolin, carbon black, chrome yellow, yellow iron oxide, colcothar, red oxide of iron, barium sulfate, alumina, zirconia, iron oxide-based pigments, iron hydroxide-based pigments, chromium oxide-based pigments, spinel-type calcined pigments, chromic acid-based pigments, chrome vermilion-based pigments, iron blue-based pigments, aluminum powder-based pigments, bronze powder-based pigments, and calcium phosphate; and organic pigments, such as phthalocyanine-based pigments such as phthalocyanine blue and phthalocyanine green, azo-based pigments, condensed azo-based pigments, azo lake-based pigments, anthraquinone-based pigments, indigo-based pigments, thioindigo-based pigments, isoindolinone-based pigments, azomethine azo-based pigments, aniline black-based pigments, triphenylmethane-based pigments, perinone-based pigments, perylene-based pigments, quinophthalone-based pigments, dioxazine-based pigments, and quinacridone-based pigments, such as quinacridone red.

In an embodiment where concealing property is required for the decorative film, the pigment preferably contains a white pigment, such as titanium oxide, zinc carbonate, zinc oxide, zinc sulfide, calcium carbonate, or barium sulfate, particularly titanium oxide. Titanium oxide acts as a flame retardant and can also increase flame retardance of the decorative film.

In an embodiment where the pigment contains a white pigment, the content of the white pigment in the acrylic pressure-sensitive adhesive layer is from approximately 30 parts by mass to approximately 60 parts by mass based on 100 parts by mass of the acrylic adhesive polymer. The acrylic pressure-sensitive adhesive layer containing approximately 30 parts by mass or greater of a white pigment per 100 parts by mass of the acrylic adhesive polymer, can partially or completely hide an adherend (underlying layer) surface to which the decorative film is applied. The acrylic pressure-sensitive adhesive layer containing approximately 60 parts by mass or less of a white pigment based on 100 parts by mass of the acrylic adhesive polymer can enhance adhesion under low temperature conditions. In an embodiment, the content of the white pigment in the acrylic pressure-sensitive adhesive layer is approximately 35 parts by mass or greater, or approximately 40 parts by mass or greater, and approximately 55 parts by mass or less, or approximately 50 parts by mass or less per 100 parts by mass of the acrylic adhesive polymer.

For the pigment, a metal pigment can also be used. Using a metal pigment can impart metallic luster to the decorative film. The metal contained in the metal pigment is not particularly limited, and examples include aluminum, zinc, iron, magnesium, copper, nickel, and their alloys. The metal pigment preferably contains aluminum because aluminum can provide metallic luster effectively with smaller amount and is less expensive.

The metal pigment may be a resin-coated metal pigment. The resin-coated metal pigment is a pigment in which at least a part of a surface of a metal pigment is covered by a resin, and exhibits excellent compatibility with the acrylic adhesive polymer. Using a resin-coated metal pigment can impart a metallic appearance to the acrylic pressure-sensitive adhesive layer and can also enhance adhesion under low temperature conditions.

The raw material constituting the resin coating of the resin-coated metal pigment is not particularly limited, and examples include acrylic resins, polyolefin, polybutadiene, poly(vinyl chloride), poly(vinylidene chloride), poly(vinyl acetate), fluororesins, poly(vinyl ether), polystyrene, and copolymers and blends of these. Because of excellent compatibility with the acrylic adhesive polymer, the resin-coated metal pigment preferably contains the acrylic resin coating.

A shape of the metal pigment is not particularly limited, and examples include a scale-like shape, a spherical shape, a needle-like shape, and a lump-like shape. The metal pigment is preferably in a scale-like shape because such a pigment can effectively provide metallic luster with smaller amount of use.

In an embodiment, an average particle size of the metal pigment is approximately 5 μm or greater, approximately 7 μm or greater, or approximately 10 μm or greater, and approximately 70 μm or less, approximately 50 μm or less, or approximately 40 μm or less. With the average particle size of the metal pigment in the above range, the metal pigment can be more uniformly dispersed in the acrylic pressure-sensitive adhesive layer. The average particle size of the metal pigment is a volume cumulative particle size D₅₀ that can be determined using laser diffraction/scattering particle size distribution measurement.

In an embodiment where the pigment contains a metal pigment, the content of the metal pigment in the acrylic pressure-sensitive adhesive layer is from approximately 3 parts by mass to approximately 30 parts by mass per 100 parts by mass of the acrylic adhesive polymer. When the acrylic pressure-sensitive adhesive layer contains approximately 3 parts by mass or greater of a metal pigment per 100 parts by mass of the acrylic adhesive polymer, metallic luster can be effectively imparted to the decorative film. When the acrylic pressure-sensitive adhesive layer contains approximately 30 parts by mass or less of the metal pigment per 100 parts by mass of the acrylic adhesive polymer, adhesion under low temperature conditions can be enhanced. In an embodiment, the content of the metal pigment in the acrylic pressure-sensitive adhesive layer is approximately 4 parts by mass or greater, or approximately 5 parts by mass or greater, and approximately 25 parts by mass or less, or approximately 20 parts by mass or less based on 100 parts by mass of the acrylic adhesive polymer.

In an embodiment where the pigment contains a metal pigment, it may be advantageous that the film layer has a visible light transmission of approximately 80% or greater, approximately 85% or greater, or approximately 90% or greater. Enhancing the visible light transmission of the film layer enables a more direct visual recognition of the metallic luster of the acrylic pressure-sensitive adhesive layer through the film layer.

The acrylic pressure-sensitive adhesive layer may also contain a dye in addition to the pigment. One type of dye may be used, or two or more types of dyes may be used in combination. Examples of the dye include azo-based dyes, anthraquinone-based dyes, quinophthalone-based dyes, styryl-based dyes, diphenylmethane-based dyes, triphenylmethane-based dyes, oxazine-based dyes, triazine-based dyes, xanthane-based dyes, azomethine-based dyes, acridine-based dyes, and diazine-based dyes.

The acrylic pressure-sensitive adhesive layer may further contain a dispersant that enhances dispersibility of the pigment in the acrylic adhesive polymer. Examples of the dispersant include low molecular weight dispersants including anionic compounds, cationic compounds, and nonionic compounds, and high molecular weight dispersants having an anionic, cationic, or nonionic polar group. The dispersant may be used alone, or a combination of two or more types of dispersants may be used.

The dispersant preferably has an acidic group or a basic group. A dispersant having an acidic group or a basic group can effectively disperse the pigment in the acrylic adhesive polymer. In an embodiment where the acrylic adhesive polymer includes a carboxy group-containing (meth)acrylic polymer, the dispersant having a basic group can enhance cohesive force of the acrylic pressure-sensitive adhesive layer by the interaction with the carboxy group-containing (meth)acrylic polymer and, by this, adhesive strength and retention strength of the acrylic pressure-sensitive adhesive layer can be enhanced.

In an embodiment, the dispersant contains a polymeric dispersant selected from the group consisting of carboxy group-containing (meth)acrylic polymers and amino group-containing (meth)acrylic polymers.

Examples of the carboxy group-containing (meth)acrylic polymer as the polymeric dispersant include copolymers containing a structural unit derived from the polymerizable component similar to the component for the carboxy group-containing (meth)acrylic polymer described in relation to the acrylic adhesive polymer. A weight average molecular weight of the carboxy group-containing (meth)acrylic polymer as the polymeric dispersant is preferably approximately 200000 or greater, approximately 300000 or greater, approximately 400000 or greater, or approximately 500000 or greater. It should be noted that, in the present disclosure, a polymer that functions as a polymeric dispersant and also corresponds to the acrylic adhesive polymer in terms of both the weight average molecular weight and the glass transition temperature is regarded as the acrylic adhesive polymer.

That is, the carboxy group-containing (meth)acrylic polymer with a weight average molecular weight of 200000 to 350000 and a glass transition temperature of −10 °C or lower may function not only as the acrylic adhesive polymer but also as the polymeric dispersant depending on the type of pigment to be used, but the content is considered as the content of the acrylic adhesive polymer.

In an embodiment, the acrylic pressure-sensitive adhesive layer contains a carboxy group-containing (meth)acrylic polymer as the acrylic adhesive polymer and an amino group-containing (meth)acrylic polymer as the polymeric dispersant. The amino group-containing (meth)acrylic polymer not only enhances dispersibility of the pigment but also has excellent miscibility with the carboxy group-containing (meth)acrylic polymer. The amino group-containing (meth)acrylic polymer can be obtained by copolymerizing a polymerizable composition containing an amino group-containing monomer as a polymerizable component, among polymerizable composition described for the acrylic adhesive polymer. As the amino group-containing monomer, dialkylamino alkyl (meth)acrylate such as N,N-dimethylaminoethyl acrylate (DMAEA) or N,N-dimethylaminoethyl methacrylate (DMAEMA) is preferred.

In an embodiment, the amino group-containing (meth)acrylic polymer is obtained by copolymerizing a polymerizable composition containing the amino group-containing monomer in an amount of approximately 0.5 mass % or greater, approximately 1 mass % or greater, or approximately 3 mass % or greater, and approximately 20 mass % or less, approximately 15 mass % or less, or approximately 10 mass % or less, relative to the mass of the polymerizable components, and includes structural units derived from the amino group-containing monomer in the mass ratio described above.

In an embodiment, the glass transition temperature (Tg) of the amino group-containing (meth)acrylic polymer is approximately 0 °C or higher, approximately 20 °C or higher, or approximately 40 °C or higher, and approximately 150 °C or less, approximately 135 °C or less, or approximately 120 °C or less. The glass transition temperature of the amino group-containing (meth)acrylic polymer can be determined by using the Fox equation similarly to the acrylic adhesive polymer.

The weight average molecular weight of the amino group-containing (meth)acrylic polymer is not particularly limited and, for example, can be approximately 1000 or greater, approximately 5000 or greater, or approximately 10000 or greater, and approximately 200000 or less, approximately 100000 or less, or approximately 80000 or less.

The content of the dispersant in the acrylic pressure-sensitive adhesive layer can be approximately 5 parts by mass or greater, approximately 10 parts by mass or greater, or approximately 20 parts by mass or greater, and approximately 500 parts by mass or less, approximately 400 parts by mass or less, or approximately 300 parts by mass or less per 100 parts by mass of the pigment.

The acrylic pressure-sensitive adhesive layer can be formed on the release liner using a pressure-sensitive adhesive composition containing the acrylic adhesive polymer, the pigment, and optionally a dispersant, a crosslinking agent, a solvent, and/or an additional additive.

Before preparing the pressure-sensitive adhesive composition, the pigment and the dispersant may be mixed to prepare a premix (also referred to as a mill base). The mixing can be performed by using, for example, a paint shaker, a sand grind mill, a ball mill, an attritor mill, or a three-roll mill. At the time of mixing, as necessary, a water-based solvent or an organic solvent may be added. The resulting premix is mixed with other components of the pressure-sensitive adhesive composition, and thus a pressure-sensitive adhesive composition that can stably disperse a large amount of the pigment in the acrylic pressure-sensitive adhesive layer can be prepared. When a plurality of pigments is used, a premix may be prepared for each pigment, and these premixes may appropriately be mixed to match color, and then the premix mixture may be mixed with other components of the pressure-sensitive adhesive composition.

A mass ratio of the total amount of the pigment to the amount of the dispersant can be (approximately from 1 to 100): (approximately from 5 to 1000), (approximately from 1 to 100): (approximately from 10 to 700), or (approximately from 1 to 100): (approximately from 10 to 500). The entire amount of the dispersant may be used during preparation of the premix, or a portion of the dispersant may be used during preparation of the premix and the rest may be used during preparation of the pressure-sensitive adhesive composition.

The crosslinking agent is not particularly limited as long as the crosslinking agent can form a crosslink between polymer chains of the acrylic adhesive polymer. By using the crosslinking agent, cohesive force of the acrylic pressure-sensitive adhesive layer can be enhanced and, by this, adhesive strength and retention strength of the acrylic pressure-sensitive adhesive layer can be enhanced. For example, in a case where the acrylic adhesive polymer is a carboxy group-containing (meth)acrylic polymer, as the crosslinking agent, an epoxy crosslinking agent, a bisamide crosslinking agent, an aziridine crosslinking agent, a carbodiimide crosslinking agent, or an isocyanate crosslinking agent can be used. The crosslinking agent may be used alone, or a combination of two or more types of crosslinking agents may be used.

Examples of the epoxy crosslinking agent include N,N,N′,N′-tetraglycidyl-1,3-benzenedi(methanamine) (trade name: TETRAD-X (Mitsubishi Gas Chemical Company Inc., Chiyoda-ku, Tokyo, Japan), E-AX and E-5XM (both from Soken Chemical & Engineering Co., Ltd., Toshima-ku, Tokyo, Japan)); and N,N′-(cyclohexane-1,3-diylbismethylene)bis(diglycidylamine) (trade name: TETRAD-C (Mitsubishi Gas Chemical Company Inc., Chiyoda-ku, Tokyo, Japan), and E-5C (Soken Chemical & Engineering Co., Ltd., Toshima-ku, Tokyo, Japan)).

Examples of the bisamide crosslinking agent include 1,1′-(1,3-phenylenedicarbonyl)bis(2-methylaziridine), 1,4-bis(ethyleneiminocarbonylamino)benzene, 4,4′-bis(ethyleneiminocarbonylamino)diphenylmethane, and 1,8-bis(ethyleneiminocarbonylamino) octane.

Examples of the aziridine crosslinking agent include 2,2-bishydroxymethylbutanol-tris[3-(1-aziridinyl) propionate (trade name: CHEMITITE (registered trademark) PZ-33 (Nippon Shokubai Co., Ltd., Osaka-shi, Osaka, Japan), and Crosslinker CX-100 (DSM Coating Resins B.V., Zwolle, Netherlands)).

Examples of the carbodiimide crosslinking agent include Carbodilite V-03, V-05, and V-07 (all from Nisshinbo Chemical Inc., Chuo-ku, Tokyo, Japan).

Examples of the isocyanate crosslinking agent include Coronate L and Coronate HK (both from Tosoh Corporation, Minato-ku, Tokyo, Japan).

The crosslinking agent can be used in an amount of approximately 0.01 parts by mass or greater, approximately 0.02 parts by mass or greater, or approximately 0.05 parts by mass or greater, and approximately 0.5 parts by mass or less, approximately 0.4 parts by mass or less, or approximately 0.3 parts by mass or less, relative to 100 parts by mass of the acrylic adhesive polymer.

Examples of the solvent include methanol, ethanol, hexane, heptane, toluene, acetone, methyl ethyl ketone, methyl isobutyl ketone, ethyl acetate, butyl acetate, and mixed solvents thereof.

Examples of other additives include UV absorbents, antioxidants, thermal stabilizers, fillers, and tackifiers.

The content of the acrylic adhesive polymer in the acrylic pressure-sensitive adhesive layer is from approximately 70 mass % to approximately 100 mass % based on the mass of all resin components. With the acrylic adhesive polymer contained in the acrylic pressure-sensitive adhesive layer in the above range, a pressure-sensitive adhesive composition that can impart both properties of low modulus of elasticity and high cohesive force to the acrylic pressure-sensitive adhesive layer even under low temperature conditions can be provided, and stable adhesion even under low temperature conditions can be also provided when slidability is imparted to the pressure-sensitive adhesive layer formed using the pressure-sensitive adhesive composition. In an embodiment, the content of the acrylic adhesive polymer in the acrylic pressure-sensitive adhesive layer is approximately 70 mass % or greater, or approximately 80 mass % or greater, and 100 mass % or less, or approximately 99 mass % or less based on the mass of all resin components.

The thickness of the acrylic pressure-sensitive adhesive layer is not particularly limited and, for example, can be approximately 5 μm or greater, approximately 10 μm or greater, or approximately 20 μm or greater, and approximately 200 μm or less, approximately 100 μm or less, or approximately 80 μm or less. The term “thickness of the acrylic pressure-sensitive adhesive layer” refers an interplanar distance between the interface of a layer (e.g., the film layer) in contact with the acrylic pressure-sensitive adhesive layer and the interface of the release liner with the acrylic pressure-sensitive adhesive layer, in a region of a smooth area of the acrylic pressure-sensitive adhesive layer where the region does not include the protrusion. For example, when the acrylic pressure-sensitive adhesive layer has a communication groove described later, the thickness in a smooth surface area including neither protrusion nor communication groove is defined as the thickness of the acrylic pressure-sensitive adhesive layer.

The acrylic pressure-sensitive adhesive layer further contains a plurality of particle clusters, the particle clusters each protruding from the surface of the acrylic pressure-sensitive adhesive layer or covered with the acrylic adhesive polymer; and the particle clusters being separated from each other, and the acrylic pressure-sensitive adhesive layer has protrusions each containing one or more of the particle clusters. One protrusion may contain one particle cluster or may contain two or more particle clusters. With the protrusions containing one or more of the particle clusters in the acrylic pressure-sensitive adhesive layer, the decorative film can slide along the adherend surface to a precise position after removing the release liner. Pressure is then applied from above the decorative film at a desired position on the adherend to push the protrusions containing the particle clusters into the acrylic pressure-sensitive adhesive layer. This can increase the contact area between the acrylic pressure-sensitive adhesive layer and the adherend surface and thus the decorative film is adhered to the adherend. In addition, the contact area of the acrylic pressure-sensitive adhesive layer with the adherend can be adjusted by adjusting the pressure, and thus the decorative film can be repositioned and adhered again.

The acrylic pressure-sensitive adhesive layer 14 of the decorative film 10 illustrated in FIG. 1 contains a plurality of particle clusters where each of the particle clusters contains a plurality of particles 143 and the particle clusters are separated from each other; and a protrusion 144 containing one or more of the particle clusters is formed at a portion of the one or more of the particle clusters. In the embodiment as illustrated in FIG. 1, the release liner 16 has depressions 164 that each protect one of the particle clusters.

For particles constituting the particle clusters, for example, particles of ceramic, glass, metal, or a polymer can be used.

The average particle size of the particles constituting the particle clusters is preferably less than the thickness of the acrylic pressure-sensitive adhesive layer to prevent the protrusion from affecting the film layer when the protrusion is pressed into the acrylic pressure-sensitive adhesive layer. For example, when the thickness of the acrylic pressure-sensitive adhesive layer is in the range of approximately 20 μm to approximately 40 μm, the average particle size of the particles is typically less than approximately 10 μm, preferably from approximately 0.1 μm to approximately 8 μm, and more preferably from approximately 0.2 μm to approximately 5 μm.

The distance between adjacent particle clusters can be from approximately 0.1 mm to approximately 0.5 mm and is preferably from approximately 0.2 mm to approximately 0.4 mm. With the distance between the adjacent particle clusters within the above range, good slidability and adhesion can be obtained.

The number of the plurality of particle clusters per cm² of the surface of the acrylic pressure-sensitive adhesive layer can be from approximately 100 to approximately 10000, and is preferably from approximately 200 to approximately 5000 and more preferably from approximately 400 to approximately 3000. With the number of the plurality of particle clusters within the above range, good slidability and adhesion can be obtained.

An area proportion of the plurality of particle clusters occupying the surface of the acrylic pressure-sensitive adhesive layer can be from approximately 0.1% to approximately 5%, and is preferably from approximately 0.2% to approximately 3% and more preferably from approximately 0.4% to approximately 1.5% of the surface area of the acrylic pressure-sensitive adhesive layer. With the area proportion of the plurality of particle clusters within the above range, good slidability and adhesion can be obtained.

The protrusion may take any shape, and its shape can be, for example, a hemisphere, a cylinder, a prism, a quadrangular pyramid, a truncated cone, or a truncated pyramid.

The protrusion has a bottom width from approximately 10 μm to approximately 60 μm, and preferably from approximately 15 μm to approximately 50 μm and more preferably from approximately 20 μm to approximately 40 μm. With the protrusion with a bottom width within the above range, improved slidability or air releasability can be imparted to the acrylic pressure-sensitive adhesive layer.

The protrusion has a height from approximately 5 μm to approximately 35 μm, and preferably from approximately 9 μm to approximately 30 μm and more preferably from approximately 13 μm to approximately 25 μm. With the protrusion with a height within the above range, improved slidability or air releasability can be imparted to the acrylic pressure-sensitive adhesive layer.

A distance between adjacent protrusions can be from approximately 30 μm to approximately 1000 μm, and is preferably from approximately 50 μm to approximately 750 μm and more preferably from approximately 100 μm to approximately 500 μm. When the distance between adjacent protrusions is within the above range, improved slidability or air releasability can be imparted to the acrylic pressure-sensitive adhesive layer.

In an embodiment, the acrylic pressure-sensitive adhesive layer further has a communication groove, and the release liner described later has a microstructured surface complementary to the communication groove of the acrylic pressure-sensitive adhesive layer. The acrylic pressure-sensitive adhesive layer having the communication groove can provide improved air releasability. The communication groove preferably communicates with the outside of the decorative film. Such a communication groove can impart high air releasability to the acrylic pressure-sensitive adhesive layer.

In the embodiment illustrated in FIG. 2, the acrylic pressure-sensitive adhesive layer 14 has the communication groove 145 with a trapezoidal cross section, and the release liner 16 has a microstructured surface 165 complementary to the communication groove 145 of the acrylic pressure-sensitive adhesive layer 14. In the same manner as illustrated in FIG. 1, the acrylic pressure-sensitive adhesive layer 14 illustrated in FIG. 2 contains a plurality of particle clusters, where each of the particle clusters contains a plurality of particles 143, and the plurality of particle clusters are separated from each other; and the protrusion 144 containing one or more of the particle clusters are formed at the portion of the more or more of the particle clusters. Also, in the embodiment illustrated in FIG. 2, in the same manner as illustrated in FIG. 1, the release liner 16 has depressions 164 that each protect one of the particle clusters.

The communication groove may be disposed regularly or irregularly. When a plurality of communication grooves is disposed substantially parallel to each other, a distance between the communication grooves can be from approximately 10 μm to approximately 2000 μm, and is preferably from approximately 15 μm to approximately 1500 μm and more preferably from approximately 20 μm to approximately 1000 μm. A depth of the communication groove is less than the thickness of the acrylic pressure-sensitive adhesive layer and can be, for example, from approximately 10 μm to approximately 50 μm. The maximum width of the communication groove can be from approximately 5 μm to approximately 200 μm, and is preferably from approximately 10 μm to approximately 150 μm and more preferably from approximately 20 μm to approximately 100 μm.

An area proportion of the openings of the communication groove occupying the surface of the acrylic pressure-sensitive adhesive layer can be from approximately 1% to approximately 50%, and is preferably from approximately 2% to approximately 40% and more preferably from approximately 5% to approximately 30% of the surface area of the acrylic pressure-sensitive adhesive layer. With the area proportion of the opening of the communication groove within the above range, improved slidability can be imparted to the acrylic pressure-sensitive adhesive layer, and adhesion can also be ensured.

The cross-sectional shape of the communication groove can be, for example, triangular, rectangular, trapezoidal, semi-circular, or semi-elliptical.

The release liner has the depressions that protect one or more of the particle clusters in the surface of the acrylic pressure-sensitive adhesive layer. One depression may protect one particle cluster or may protect two or more particle clusters. During storage of the decorative film, the particles constituting the particle clusters would migrate into the acrylic pressure-sensitive adhesive layer due to an external force applied to the particles, and this would reduce the slidability of the acrylic pressure-sensitive adhesive layer. The depression of the release liner can prevent such migration of the particles and decrease in the slidability. In an embodiment where the acrylic pressure-sensitive adhesive layer has the communication groove, the release liner has a microstructured surface complementary to the communication groove of the acrylic pressure-sensitive adhesive layer.

The release liner is preferably a silicone release-treated plastic film or polyethylene laminated paper. Emboss finishing can readily form a depression and if necessary a complementary microstructured surface in a plastic film or polyethylene laminated paper. Examples of the plastic film include poly(vinyl chloride) films, poly(ethylene terephthalate) films, and polypropylene films.

The release liner may be of any thickness depending on the depth of the depression, the shape of the complementary microstructured surface, and the like. The thickness can be, for example, approximately 10 μm or greater or approximately 25 μm or greater, and approximately 500 μm or less or approximately 200 μm or less.

The decorative film can be produced, for example, by the following method. A release liner with the depression and if necessary the complementary microstructured surface formed on a release-treated surface is prepared. The depression may be in the shape of, for example, an inverted truncated cone, a hemisphere, or a dish. The depression in the release liner is filled with particles. The pressure-sensitive adhesive composition is applied to the release-treated surface of the release liner by knife coating, bar coating, or the like, and the pressure-sensitive adhesive composition is brought into contact with the particles. The pressure-sensitive adhesive composition is cured by drying and if necessary heating using a hot air, an oven, or the like, and the acrylic pressure-sensitive adhesive layer is formed. The particles disposed in the depression of the release liner are at least partially embedded in the acrylic pressure-sensitive adhesive layer in a state of protruding from the surface of the acrylic pressure-sensitive adhesive layer or being covered with the acrylic adhesive polymer, and in the acrylic pressure-sensitive adhesive layer, a particle cluster and a protrusion containing the particle cluster are formed at a position of the corresponding depression of the release liner. When the release liner has the complementary microstructured surface, a communication groove is further formed in the surface of the acrylic pressure-sensitive adhesive layer.

A film layer or a laminate including a film layer is laminated on the resulting acrylic pressure-sensitive adhesive layer by a method, such as dry lamination, and the decorative film can be produced accordingly. The surface of the acrylic pressure-sensitive adhesive layer from which the release liner is removed has slidability and enables positioning or repositioning of the decorative film.

The thickness of the decorative film can be approximately 30 μm or greater, approximately 50 μm or greater, or approximately 70 μm or greater, but approximately 1 mm or less, approximately 500 μm or less, or approximately 300 μm or less. The thickness of the decorative film does not include the thickness of the release liner. The thickness of the acrylic pressure-sensitive adhesive layer, which is a reference for the thickness of the decorative film, is as defined above. In an embodiment, the thickness of the decorative film is approximately 240 μm or less. The decorative film having a thickness of approximately 240 μm or less can impart required flame retardance to the decorative film. The thickness of the decorative film required to have flame retardance is preferably approximately 200 μm or less, and more preferably approximately 180 μm or less.

In an embodiment, the decorative film effectively conceal a color, pattern, or the like of an adherend (underlying layer) surface. In this embodiment, when the decorative film is measured for a color difference ΔE* between background colors of black and white, from the film layer side in the decorative film, the color difference ΔE* is 11 or less between the black and white background color portions. A decorative film with a color difference ΔE* of 11 or less has excellent concealing property for the underlying layer and can be suitably used for car wrapping. The color difference ΔE* is determined according to the procedure described in the section “1. Concealing power” in Examples using a spectrophotometric colorimeter.

The adhesive strength (ordinary-temperature adhesive strength) of the decorative film of an embodiment is approximately 10 N/25 mm or greater, approximately 15 N/25 mm or greater, or approximately 20 N/25 mm or greater at 20 °C when measured in accordance with JIS Z 0237:2009 using an aluminum plate as an adherend. The adhesive strength of the decorative film is typically approximately 60 N/25 mm or less, approximately 50 N/25 mm or less, or approximately 40 N/25 mm or less. In the present disclosure, the measurement procedure and conditions for the ordinary-temperature adhesive strength of the decorative film refer to “2-1. Ordinary-temperature adhesive strength” described in Examples.

The adhesive strength (low-temperature adhesive strength) of the decorative film of an embodiment is approximately 10 N/25 mm or greater, approximately 15 N/25 mm or greater, or approximately 20 N/25 mm or greater at 5 °C when measured in accordance with JIS Z 0237:2009 using an aluminum plate as an adherend. The adhesive strength of the decorative film is typically approximately 50 N/25 mm or less, approximately 45 N/25 mm or less, or approximately 40 N/25 mm or less. In the present disclosure, the measurement procedure and conditions for the low-temperature adhesive strength of the decorative film refer to “2-2. Low-temperature adhesive strength” described in Examples.

The decorative film of the present disclosure can be used in applications including markings on building construction signs, vehicles, ships, aircrafts, and the like; car wrapping; interior and exterior decorations of buildings; and illuminated signs, and can be particularly suitably used in outdoor applications where working takes place throughout the year.

### EXAMPLES

In the following examples, specific embodiments of the present disclosure will be exemplified, but the present invention is not limited to those embodiments. All ‘part’ and ‘percent’ are based on mass unless otherwise specified. A numerical value essentially includes an error originated from a measurement principle and a measuring device. Numerical values including those listed in tables are presented with significant digits that is rounded.

The raw materials used in the production of the decorative film are shown in Table 1. Depressions provided on silicone-treated surfaces of a release liner 1 (L1) and a release liner 2 (L2) were in the shape of an inverted truncated cone (shape of a truncated cone turned upside down) with an opening width (width on the release face) of approximately 35 μm and a bottom width (width inside the release liner) of approximately 30 μm when these release liners were placed with the silicone-treated surface (release face) up.

TABLE 1

| | | | | Weight | | |
|---|---|---|---|---|---|---|
| | | | | average | | Solid |
| Name or | | | Tg²⁾ | molecular | | content |
| abbreviation | Composition or description¹⁾ | Supplier | [°C] | weight (Mw) | Solvent | [mass %] |
| Film 1 (FL1) | A matte finish transparent acrylic film, | 3M Japan Ltd. | — | — | — | — |
| | thickness 43 μm, obtained by removing | (Shinagawa-ku, | | | | |
| | a release sheet, a protective film layer, | Tokyo, Japan) | | | | |
| | and an adhesive from 3M (trade name) | | | | | |
| | Scotchcal (trade name) Paint Film PF | | | | | |
| | Series PF150AP | | | | | |
| Film 2 (FL2) | Denka DX Film DX-14S02, | Denka | — | — | — | — |
| | PMMA/PVdF film, transparent grade, | Company | | | | |
| | thickness: 30 μm | Limited | | | | |
| | | (Chuo-ku, | | | | |
| | | Tokyo, Japan) | | | | |
| Film 3 (FL3) | A thermoplastic polyester polyurethane | Sheedom Co., | — | — | — | — |
| | elastomer film, thickness 150 μm, non- | Ltd. | | | | |
| | yellowing | (Osaka-shi, | | | | |
| | A 30-μm thick pink polyurethane ink | Osaka, Japan) | | | | |
| | layer and a 30-μm thick transparent | | | | | |
| | polyurethane ink layer were laminated | | | | | |
| | in this order on an elastomer film | | | | | |
| Dispersant 1 | MMA-BMA-DMAEMA = 60:34:6 | — | 63 | 68000 | EtOAc | 40 |
| (DP1) | | | | | | |
| Dispersant 2 | BA-2EHA-Vac-AA-ACM = | — | −51 | 550000 | Toluene/EtOAc | 40 |
| (DP2) | 40:47:8:5:0.1 | | | | | |
| Adhesive | 2EHA-BA-AA = 64:30:6 | — | −57 | 280000 | EtOAc | 60 |
| polymer 1 | | | | | | |
| (ADH1) | | | | | | |
| Adhesive | BA-2EHA-AN-AA = 58:36:2:4 | — | −53 | 500000 | EtOAc | 33 |
| polymer 2 | | | | | | |
| (ADH2) | | | | | | |
| Crosslinking | Tetrad-X, polyfunctional liquid epoxy | Mitsubishi Gas | — | — | — | 100 |
| agent 1 | resin, N,N,N′,N′-tetraglycidyl-m- | Chemical | | | | |
| (CL1) | xylenediamine | Company, Inc. | | | | |
| | | (Chiyoda-ku, | | | | |
| | | Tokyo, Japan) | | | | |
| Crosslinking | Bisamide type crosslinking agent, 1,1′- | 3M Japan Ltd. | | | Toluene | 5 |
| agent 2 | isophthaloyl-bis(2-methylaziridine) | (Shinagawa-ku, | | | | |
| (CL2) | | Tokyo, Japan) | | | | |
| Aluminum | TR-2130, acrylic resin-coated aluminum | Asahi Kasei | — | — | MS/SN | 60 |
| paste 1 | paste, volume average particle size Dv | Metals | | | | |
| (AP1) | 13 μm | Corporation | | | | |
| | | (Chiyoda-ku, | | | | |
| | | Tokyo, Japan) | | | | |
| Aluminum | HR-9901, acrylic resin-coated | Asahi Kasei | — | — | MS/SN | 55 |
| paste 2 | aluminum paste, volume average | Metals | | | | |
| (AP2) | particle size Dv 20 μm | Corporation | | | | |
| | | (Chiyoda-ku, | | | | |
| | | Tokyo, Japan) | | | | |
| Aluminum | HR-800, acrylic resin-coated aluminum | Asahi Kasei | — | — | MS/SN | 61 |
| paste 3 | paste, volume average particle size Dv | Metals | | | | |
| (AP3) | 34 μm | Corporation | | | | |
| | | (Chiyoda-ku, | | | | |
| | | Tokyo, Japan) | | | | |
| Release liner | 3M (trade name) Controltac (trade | 3M Japan Ltd. | — | — | — | — |
| 1 (L1) | name) Graphic Film Liner | (Shinagawa-ku, | | | | |
| | Release sheet laminated with | Tokyo, Japan) | | | | |
| | polyethylene on both sides and treated | | | | | |
| | with silicone on one side | | | | | |
| | Depression shape, inverted truncated | | | | | |
| | cone shape; depression depth, | | | | | |
| | approximately 18 μm; depression | | | | | |
| | distance, approximately 300 μm; | | | | | |
| | depression opening width, | | | | | |
| | approximately 35 μm; depression | | | | | |
| | bottom portion width, approximately 30 μm | | | | | |
| | Having particles in the depressions | | | | | |
| Release liner | 3M (trade name) Controltac (trade | 3M Japan Ltd. | — | — | — | — |
| 2 (L2) | name) Comply (trade name) Graphic | (Shinagawa-ku, | | | | |
| | Film Liner | Tokyo, Japan) | | | | |
| | Release sheet laminated with | | | | | |
| | polyethylene on both sides and treated | | | | | |
| | with silicone on one side | | | | | |
| | Complementary microstructured | | | | | |
| | surface, protrusion portions linearly | | | | | |
| | provided on the entire liner surface; | | | | | |
| | Cross-sectional shape of protrusion | | | | | |
| | portion, trapezoid; protrusion portion | | | | | |
| | height, approximately 28 μm; distance | | | | | |
| | between protrusion portions, | | | | | |
| | approximately 340 μm; top portion | | | | | |
| | width of protrusion portion, 40 μm; | | | | | |
| | bottom portion width of protrusion | | | | | |
| | portion, approximately 50 μm | | | | | |
| | Depressions are the same as L1 | | | | | |

¹⁾BA, n-butyl acrylate; 2EHA, 2-ethylhexyl acrylate; Vac, vinyl acetate; AA, acrylic acid; ACM, acrylamide; AN, acrylonitrile MMA, methyl methacrylate; BMA, butyl methacrylate; DMAEMA, dimethylaminoethyl methacrylate EtOAc, ethyl acetate; MS, mineral spirit; SN, solvent naphtha
²⁾Value calculated using Fox equation

The pigments 1 to 4 used in the production of the decorative films are shown in Table 2.

TABLE 2

| | Color | C.I. | Description | Supplier |
|---|---|---|---|---|
| Pigment 1 | Red | Pigment | IRGAZIN (trade name) | BASF |
| (PG1) | | Red 255 | DPP RED BO | (Basel, Switzerland) |
| Pigment 2 | Yellow | Pigment | IRGAZIN (trade name) | BASF |
| (PG2) | | Yellow 154 | YELLOW 2GLTE | (Basel, Switzerland) |
| Pigment 3 | Black | Pigment | Raven (trade name) Carbon | Columbian Chemicals Company |
| (PG3) | | Black 7 | Black 1200 | (Marietta, Georgia, US) |
| Pigment 4 | White | Pigment | Ti-Pure (trade name) R960, | The Chemours Company |
| (PG4) | | White 6 | titanium dioxide (TiO₂) | (Wilmington, Delaware, US) |

The compositions of Millbases 1 to 4 (premixes) used in production of decorative films are shown in Table 3.

TABLE 3

| | | | Dispersant | | |
|---|---|---|---|---|---|
| | | | | mass % | |
| | Pigment | | | (solid | |
| | Type | mass % | Type | content) | Solvent¹⁾ |
| Millbase 1 (MB1) | PG1 | 10 | DP2 | 16 | EtOAc |
| Millbase 2 (MB2) | PG2 | 5 | DP2 | 20 | EtOAc |
| Millbase 3 (MB3) | PG3 | 5 | DP2 | 20 | EtOAc |
| Millbase 4 (MB4) | PG4 | 55 | DP1 | 11 | MEK |

¹⁾MEK, methyl ethyl ketone; EtOAc, ethyl acetate

The compositions of pressure-sensitive adhesive compositions CA1 to CA5 and WA1 to WA2 used in production of decorative films are shown in Table 4. MB1 and MB2 were used in preparation of CA2. MB2 and MB3 were used in preparation of CA3. MB2 was used in preparation of CA4 and CA5. MB4 was used in preparation of WA1 and WA2.

TABLE 4
(Numerical values are in dry mass %)

| | CA1 | CA2 | CA3 | CA4 | CA5 | WA1 | WA2 |
|---|---|---|---|---|---|---|---|
| PG1 | — | 0.1 | — | — | — | — | — |
| PG2 | — | 1.6 | 5.2 | 0.2 | 0.2 | — | — |
| PG3 | — | — | 0.1 | — | — | — | — |
| PG4 | — | — | — | | — | 27.0 | 27.0 |
| DP1 | 6.7 | 7.1 | 6.6 | 6.9 | 6.8 | 5.4 | 5.4 |
| DP2 | — | 2.6 | 8.4 | 0.8 | 0.8 | — | — |
| AP1 | 2.3 | 0.8 | 1.4 | — | — | — | — |
| AP2 | 7.7 | — | — | — | 2.8 | — | — |
| AP3 | — | 1 | 4.5 | 6.8 | 4.4 | — | — |
| ADH1 | 83.2 | 86.7 | 73.7 | 85.2 | 84.9 | 67.5 | 67.5 |
| CL1 | 0.1 | 0.1 | 0.1 | 0.1 | 0.1 | 0.08 | 0.04 |
| Solid content (mass %) | 47 | 50 | 45 | 48 | 48 | 58 | 58 |

### Example 1

The pressure-sensitive adhesive composition CA1 was applied on the release liner 1 (L1) with a knife coater. The coated layer was dried at 95 °C for 5 minutes. After the drying, an acrylic pressure-sensitive adhesive layer with a thickness of 38 μm was obtained. The acrylic pressure-sensitive adhesive layer and the film 1 (FL1) were adhered together, the acrylic pressure-sensitive adhesive layer was transferred to FL1, and a decorative film of Example 1 was obtained.

### Examples 2 to 11

Decorative films of Examples 2 to 11 were obtained by the same procedure as in Example 1 except for the changes in the pressure-sensitive adhesive composition, the thickness of the acrylic pressure-sensitive adhesive layer, and the release liner to those shown in Table 5.

Upon removing the release liner from the laminate obtained by applying the pressure-sensitive adhesive composition on the release liner L1, drying, and adhering it to the film, the particles filled in the depressions in the release liner are transferred as the protrusions to the pressure-sensitive adhesive layer surface, and a microstructure can be provided on the pressure-sensitive adhesive layer surface. The acrylic pressure-sensitive adhesive layer formed using L1 as the release liner had a plurality of protrusions at distances of approximately 300 μm at positions corresponding to the depressions in L1, the protrusions being in the shape of truncated cones with a top portion diameter of approximately 30 μm, a bottom portion diameter of approximately 35 μm, and a height of approximately 18 μm, and containing particles.

Upon removing the release liner from the laminate obtained by applying the pressure-sensitive adhesive composition on the release liner L2, drying, and adhering it to the film, the particles filled in the depressions in the release liner are transferred as the protrusions to the pressure-sensitive adhesive layer surface, and furthermore, communication grooves are transferred to the pressure-sensitive adhesive layer surface, and a microstructure can be provided on the pressure-sensitive adhesive layer surface. The acrylic pressure-sensitive adhesive layer formed using L2 as the release liner had a plurality of protrusions at distances of approximately 300 μm at positions corresponding to the depressions in L2, the protrusions being in the shape of truncated cones with top portion diameters of approximately 30 μm, bottom portion diameters of approximately 35 μm, and heights of approximately 18 μm, and containing particles, and further had linearly extending communication grooves at distances of approximately 340 μm at positions corresponding to the complementary microstructured surface (protrusion portions linearly provided on the entire liner surface) of L2, the communication grooves with cross-sectional shapes of trapezoids with opening widths of approximately 50 μm, bottom portion widths of approximately 40 μm, and heights of approximately 28 μm.

### Comparative Example 1

A 3M (trade name) Scotchcal (trade name) Film JS1805XL Silver Metallic Film (3M Japan Limited, Shinagawa-ku, Tokyo, Japan) was used.

### Example 12

The pressure-sensitive adhesive composition WA1 was applied on the release liner 1 (L1) with a knife coater. The coated layer was dried at 95 °C for 5 minutes. After the drying, an acrylic pressure-sensitive adhesive layer with a thickness of 38 μm was obtained. The acrylic pressure-sensitive adhesive layer and the film 2 (FL2) were adhered together and the acrylic pressure-sensitive adhesive layer was transferred to FL2, and a decorative film of Example 12 was obtained.

### Examples 13 to 19

Decorative films of Examples 13 to 19 were obtained by the same procedure as in Example 12 except for the changes in the film layer, the pressure-sensitive adhesive composition, and the thickness of the acrylic pressure-sensitive adhesive layer to those shown in Table 6.

### Comparative Example 2

The adhesive polymer 2 (ADH2) and the crosslinking agent 2 (CL2) were mixed, and a pressure-sensitive adhesive composition was prepared. The mass ratio of ADH2 and CL2 was 100:0.20 in terms of solid content. The pressure-sensitive adhesive composition was applied on the release liner 1 (L1) with a knife coater. The coated layer was dried at 95 °C for 5 minutes. After the drying, the acrylic pressure-sensitive adhesive layer having a thickness of 30 μm was obtained. The acrylic pressure-sensitive adhesive layer and the film 3 (FL3) were adhered together and the acrylic pressure-sensitive adhesive layer was transferred to FL3, and a decorative film of Comparative Example 2 was obtained.

The decorative film was evaluated for the following.

### 1. Concealing Power

A test piece was prepared by cutting the decorative film into a rectangle with a length of 100 mm and a width of 50 mm. The test piece was adhered on a concealing power chart (checks, concealing power chart, SEIEIDO Printing Co., Ltd. (Yonezawa-shi, Yamagata, Japan)). For the black and white areas, the L*, a*, and b* values of the test piece were measured using a spectrophotometric colorimeter (CM-3700d, Konica Minolta Japan, Inc. (Minato-ku, Tokyo, Japan)). When the measured values of the white area were denoted by L₁*, a₁*, and b₁*, and the measured values of the black region were denoted by L2*, a₂*, and b₂*, the color difference ΔE* was calculated and determined as an index of concealing power by the following equation: ΔE*=[(L2*−L1*) 2+ (a₂*−a₁*) 2+ (b₂*−b₁*)²]^{1/2}.

A decorative film with a ΔE* of less than 6 was rated A, 6 or greater and less than 12 rated B, and 12 or greater rated C. A decorative film rated A or B was considered to have concealing power.

### 2-1. Ordinary-Temperature Adhesive Strength

A test piece was prepared by cutting the decorative film into a rectangle with a length of 150 mm and a width of 25 mm. The test piece was adhered on a melamine-coated sheet (Paltek Corporation, Hiratsuka-shi, Kanagawa, Japan) or an aluminum plate (Paltek Corporation, Hiratsuka-shi, Kanagawa, Japan) at 20 °C. The adhering method was in accordance with JIS Z 0237:2009 8.2.3. The test piece was left at 20 °C for 48 hours. Using a tensile tester (Tensilon (registered trademark) universal testing machine, model: RTC-1210A, A&D Company, Limited, Toshima-ku, Tokyo, Japan), the adhesive strength (N/25 mm) at the time of performing 180-degree peeling was measured at a peeling rate of 300 mm/min at a temperature of 20 °C.

### 2-2. Low-Temperature Adhesive Strength

A test piece was prepared by cutting the decorative film into a rectangle with a length of 150 mm and a width of 25 mm. The test piece was adhered on a melamine-coated sheet (Paltek Corporation, Hiratsuka-shi, Kanagawa, Japan) or an aluminum plate (Paltek Corporation, Hiratsuka-shi, Kanagawa, Japan) at 5 °C. The adhering method was in accordance with JIS Z 0237:2009 8.2.3. The test piece was left at 5 °C for 24 hours. Using a tensile tester (Tensilon (registered trademark) universal testing machine, model: RTC-1210A, A&D Company, Limited, Toshima-ku, Tokyo, Japan), the adhesive strength (N/25 mm) at the time of performing 180-degree peeling was measured at a peeling rate of 300 mm/min at a temperature of 20 °C.

### 3. Slidability

A test piece was prepared by cutting the decorative film into a rectangle with a length of 100 mm and a width of 50 mm. The release liner was removed, and the adhesive surface of the test piece was brought into light contact with a glass plate at 25 °C. A rectangular parallelepiped weight (bottom surface 40 mm×60 mm, mass approximately 40 g) was placed on the test piece. A case where the test piece could slide on the glass plate with the weight placed on the test piece was rated “good”, and a case where the test piece adhered to the glass plate and failed to slide with the weight placed on the test piece was rated “poor”.

### 4. Air Releasability

A test piece was prepared by cutting the decorative film into a rectangle with a length of 100 mm and a width of 50 mm. The release liner was removed, and the adhesive surface of the test piece was brought into light contact with a glass plate at 25 °C. The test piece was rubbed while pressure was applied to the test piece using a squeegee. A case where no bubble remained between the test piece and the glass plate was rated “good”, and a case where a bubble remained between the test piece and the glass plate was rated “poor”.

### 5. Heat Shrinkage

A test piece was prepared by cutting the decorative film into a rectangle with a length of 100 mm and a width of 50 mm. The test piece was adhered on an aluminum plate (Paltek Corporation, Hiratsuka-shi, Kanagawa, Japan) with a roller in an environment of 23 °C and left in an environment of 23 °C for 24 hours. A cross-shaped cut was made on the test piece with a utility knife. The test piece was then heated at 65 °C for 48 hours. After the heat aging, the shrinkage (mm) of the film was measured by a microscope, and a maximum value was recorded.

The evaluation results of the decorative films of Examples 1 to 11 and Comparative Example 1 are shown in Table 5.

TABLE 5

| | | Pressure- | | | | Acrylic pressure- |
|---|---|---|---|---|---|---|
| | | sensitive | | | | sensitive adhesive |
| | Film | adhesive | | Release | Crosslinking | layer thickness |
| | layer | composition | Appearance | liner | agent | [μm] |
| Example 1 | FL1 | CA1 | Silver | L1 | CL1 | 38 |
| Example 2 | FL1 | CA1 | Silver | L2 | CL1 | 52 |
| Example 3 | FL1 | CA2 | Gold | L1 | CL1 | 38 |
| Example 4 | FL1 | CA2 | Gold | L1 | CL1 | 53 |
| Example 5 | FL1 | CA2 | Gold | L2 | CL1 | 52 |
| Example 6 | FL1 | CA3 | Gold | L1 | CL1 | 39 |
| Example 7 | FL1 | CA3 | Gold | L2 | CL1 | 49 |
| Example 8 | FL1 | CA4 | Silver | L1 | CL1 | 44 |
| Example 9 | FL1 | CA4 | Silver | L2 | CL1 | 54 |
| Example 10 | FL1 | CA5 | Silver | L1 | CL1 | 43 |
| Example 11 | FL1 | CA5 | Silver | L2 | CL1 | 55 |
| Comparative | — | — | Silver | — | — | — |
| Example 1 | | | | | | |

| | Concealing | | Adhesive strength | | | | Heat |
|---|---|---|---|---|---|---|---|
| | power | | [N/25 mm] | | | Air | shrinkage |
| | ΔE* | Rating | Coated sheet | Al | Slidability | releasability | [mm] |
| Example 1 | 0.04 | A | 18 | 23 | Good | Poor | 0.16 |
| Example 2 | 0.08 | A | 15 | 20 | Good | Good | 0.15 |
| Example 3 | 19.36 | C | 17 | 21 | Good | Poor | 0.14 |
| Example 4 | 11.59 | B | 15 | 22 | Good | Good | 0.14 |
| Example 5 | 13.00 | C | 17 | 19 | Good | Good | 0.15 |
| Example 6 | 1.31 | A | 17 | 21 | Good | Poor | 0.14 |
| Example 7 | 0.46 | A | 14 | 18 | Good | Good | 0.14 |
| Example 8 | 0.69 | A | 19 | 24 | Good | Poor | 0.18 |
| Example 9 | 0.11 | A | 14 | 20 | Good | Good | 0.14 |
| Example 10 | 0.15 | A | 19 | 24 | Good | Poor | 0.18 |
| Example 11 | 0.63 | A | 15 | 20 | Good | Good | 0.20 |
| Comparative | 0.25 | A | 29 | 34 | Poor | Poor | 0.20 |
| Example 1 | | | | | | | |

The evaluation results of the decorative films of Examples 12 to 19 and Comparative Example 2 are shown in Table 6.

TABLE 6
(N.D. means not determined)

| | | | | | Acrylic | | | | | | | |
|---|---|---|---|---|---|---|---|---|---|---|---|---|
| | | | | | pressure- | | | | | Low-temperature | | |
| | | | | | sensitive | | | Adhesive | | adhesive strength | | |
| | | Pressure- | | | adhesive | | | strength | | (5 °C) | | |
| | | sensitive | | | layer | Concealing | | [N/25 mm] | | [N/25 mm] | | Heat |
| | Film | adhesive | Release | Crosslinking | thickness | power | | Coated | | Coated | | shrinkage |
| | layer | composition | liner | agent | [μm] | ΔE* | Rating | sheet | Al | sheet | Al | [mm] |
| Example 12 | FL2 | WA1 | L1 | CL1 | 38 | 2.4 | A | 17 | 26 | ND | ND | ND |
| Example 13 | FL2 | WA2 | L1 | CL1 | 35 | 2.7 | A | 20 | 31 | ND | ND | 0.14 |
| Example 14 | FL2 | WA1 | L1 | CL1 | 46 | 2.3 | A | 17 | 24 | ND | ND | 0.13 |
| Example 15 | FL2 | WA2 | L1 | CL1 | 45 | 2.2 | A | 23 | 37 | ND | ND | 0.14 |
| Example 16 | FL3 | WA1 | L1 | CL1 | 38 | 0.6 | A | 9 | 33 | 9 | 32 | 0.19 |
| Example 17 | FL3 | WA2 | L1 | CL1 | 35 | 0.6 | A | 17 | 45 | 6 | 34 | 0.32 |
| Example 18 | FL3 | WA1 | L1 | CL1 | 46 | 0.4 | A | 10 | 28 | 8 | 34 | 0.21 |
| Example 19 | FL3 | WA2 | L1 | CL1 | 45 | 0.4 | A | 23 | 54 | 11 | 37 | 0.29 |
| Comparative | FL3 | ADH2 | L1 | CL2 | 30 | 2.0 | A | 4 | 9 | 10 | 28 | 0.10 |
| Example 2 | | | | | | | | | | | | |

1. A positionable and repositionable decorative film comprising:
a film layer,
an acrylic pressure-sensitive adhesive layer including an acrylic adhesive polymer and a pigment, and
a release liner,
wherein the acrylic adhesive polymer has a weight average molecular weight of 200000 to 350000,
the acrylic adhesive polymer has a glass transition temperature of −10 °C or lower,
the acrylic pressure-sensitive adhesive layer comprises from 3 parts by mass to 60 parts by mass of the pigment per 100 parts by mass of the acrylic adhesive polymer,
a content of the acrylic adhesive polymer in the acrylic pressure-sensitive adhesive layer is from 70 mass % to 100 mass % based on mass of all resin components,
the acrylic pressure-sensitive adhesive layer further includes a plurality of particle clusters, the particle clusters each protruding from a surface of the acrylic pressure-sensitive adhesive layer or covered with the acrylic adhesive polymer; and the particle clusters being separated from each other, and the acrylic pressure sensitive adhesive layer includes protrusions each including one or more of the particle clusters, and
the release liner includes depressions each protecting one or more of the particle clusters.

2. The decorative film according to claim 1, wherein the pigment includes a metal pigment, and a content of the metal pigment in the acrylic pressure-sensitive adhesive layer is from 3 parts by mass to 30 parts by mass per 100 parts by mass of the acrylic adhesive polymer.

3. The decorative film according to claim 1, wherein the pigment includes a white pigment, and a content of the white pigment in the acrylic pressure-sensitive adhesive layer is from 30 parts by mass to 60 parts by mass per 100 parts by mass of the acrylic adhesive polymer.

4. The decorative film according to claim 1, wherein the acrylic pressure-sensitive adhesive layer includes a carboxy group-containing (meth)acrylic polymer and an amino group-containing (meth)acrylic polymer.

5. The decorative film according to claim 1, wherein the acrylic pressure-sensitive adhesive layer further includes a communication groove, and the release liner includes a microstructured surface complementary to the communication groove of the acrylic pressure-sensitive adhesive layer.

6. The decorative film according to claim 1, wherein, when the decorative film is measured for a color difference ΔE* between background colors of black and white, from the film layer side in the decorative film, the color difference ΔE* is 11 or less between the black and white background color portions.

7. The decorative film according to claim 1, wherein the decorative film has an adhesive strength of 10 N/25 mm or greater at 5 °C when the decorative film is measured for the adhesive strength using an aluminum plate as an adherend in accordance with JIS Z 0237:2009.
